(19) United States
(12) Patent Application Publication
(10) Pub. No.: US 2011/0117530 A1
(43) Pub. Date: May 19, 2011

(54) METHOD AND SYSTEM OF SIMULATING PHYSICAL OBJECT INCISIONS, DEFORMATIONS AND INTERACTIONS THEREWITH

(75) Inventors: Dan ALBOCHER, Beit-Hanan (IL); Gershon Elber, Haifa (IL)

(73) Assignee: Technion Research & Development Foundation Ltd., Haifa (IL)

(21) Appl. No.: 12/775,501

(22) Filed: May 7, 2010

Related U.S. Application Data
(60) Provisional application No. 61/176,212, filed on May 7, 2009.

(51) Int. Cl. G09B 23/28; G06G 7/48; G06G 7/60; G06F 17/50

(52) U.S. Cl. 434/267; 703/6; 703/11; 703/1

(57) ABSTRACT

A method of simulating a formation of an incision or a deformation in a physical object. The method comprises spatially simulating a physical object in a simulation space using a volumetric arrangement of a plurality of prismatic elements, each the prismatic element having at least one adjustable parameter simulating a physical property of a respective segment of the physical object, measuring a movement of at least one simulation tool in the simulation space, selecting at least one of the plurality of prismatic elements according to the measurement, adjusting at least one adjustable parameter of at least one selected prismatic element according to the measurement, and spatially simulating an incision or deformation formed in the physical object in response to the movement using the adjusted volumetric arrangement.

### RELATED APPLICATION

This application claims the benefit of priority under 35 U.S.C. §119(e) of U.S. Provisional Patent Application No. 61/176,212, filed on May 7, 2009, the contents of which are incorporated by reference as if fully set forth herein.

### FIELD AND BACKGROUND OF THE INVENTION

The present invention, in some embodiments thereof, relates to method and system of simulation and, more particularly, but not exclusively, to method and system of simulating surface incisions, deformations and interactions therewith.

Computer-aided simulation and virtual-reality training, such as surgical simulation, medical treatment simulation, and manual work simulation, is a topic of increasingly extensive research. Computer graphics, geometric modeling and finite element analysis all play major roles in these simulations. Furthermore, real-time response, interactivity and accuracy are crucial components in any such simulation system. A major effort has been invested in recent years to find ways to improve the performance, accuracy and realism of existing systems.

In order to maximize the potential gain in such simulation or virtual-reality training, a simulation system should replicate the environment as closely as possible in terms of look and feel. When the simulation is a surgical simulation, it is important to realistically animate, in real-time, the way tissue, such as skin, Cornea, fat, muscle, bone and/or internal organs, behaves under surgical operations, such as marking, tweezing, stretching, suturing, and/or cutting. The simulation is usually done with a user interface such as a movement measuring unit provides interaction behavior, both from the visual and the tactile point of view. An example for a movement measuring unit used for a surgical simulation is the PHANTOM Omni® movement measuring unit of SensAble Technologies, which the specification and manual thereof in incorporated herein by reference

The simulation of physical objects, such as continuous surfaces, for example biological tissues and rubber-like composites and the operation of cutting such surfaces is usually performed with surface meshes. When such a surface mesh simulates a cut, a surface modeling task, in which a model surface of the surface mesh is split along a route of a cutting tool or an imaginary cutting tool, such as scalpel, as it advances. Then, the geometry around the cut is changed to reflect the shape and orientation of the cutting tool and the internal strain and stress properties of the simulated surface. A framework for simulating a tissue and a cutting operation is described in Guy Sela et. Al., Real-time Haptic Incision Simulation using FEM-based Discontinuous Free Form Deformation, Proceedings of the 2006 ACM symposium on Solid and physical modeling, Cardiff, Wales, United Kingdom, Simulation techniques, Pages: 75-84, 2006, ISBN:1-59593-358-1, which is incorporated herein by reference. The framework is based upon an augmented variant of Free Form Deformation (FFD), which allows discontinuities and openings to be created in geometric models, see SEDERBERG, T. W., AND PARRY, S. R. 1986. Free-form deformation of solid geometric models. Computer Graphics 20 (August), 151-160, which is incorporated herein by reference. The discontinuous FFD (DFFD) is continuous everywhere except at the incision, and hence it has the ability to continuously deform the geometry around the cut, see Schein, S., and Elber, G. 2005, discontinuous free-form deformation, the 12th pacific conference on graphics and applications (PG), 227-236, which is incorporated herein by reference. DFFD can be used to incorporate discontinuities and deform the model properly while automatically allowing it to split and re-form at the proper locations.

### SUMMARY OF THE INVENTION

According to some embodiments of the present invention there is provided a method of simulating a formation of an incision or a deformation in a physical object. The method comprises spatially simulating a physical object in a simulation space using a volumetric arrangement of a plurality of prismatic elements, each the prismatic element having at least one adjustable parameter simulating a physical property of a respective segment of the physical object, measuring a movement of at least one simulation tool in the simulation space, selecting at least one of the plurality of prismatic elements according to the measurement, adjusting the at least one adjustable parameter of the at least one selected prismatic element according to the measurement, and spatially simulating at least one of a deformation or an incision formed in the physical object in response to the movement using the adjusted volumetric arrangement.

Optionally, each the prismatic element has triangular bases. Optionally, each the adjustable parameter includes a plurality of masses and a plurality of adjustable springs, each the mass being connected to another the mass by one of the plurality of adjustable springs; the adjusting comprises adjusting at least one respective the adjustable spring.

More optionally, each the adjustable spring has a length limitation simulating a surface stretchability coefficient, the adjusting being performed under respective the length limitation.

More optionally, the surface stretchability coefficient is a living skin tissue stretchability coefficient.

More optionally, the adjusting comprises computing at least one of external and internal forces for each the adjustable spring of the at least one adjustable parameter, accumulating the external and internal forces in respective the masses, calculating a relocation of the respective masses according to the accumulated forces and performing the adjusting according to the relocation.

Optionally, each the at least one adjustable parameter has at least one physical limitation and the adjusting being performed under respective the at least one physical limitation.

Optionally, the method further comprises repeating the b)-e) using the deformed volumetric arrangement instead of the volumetric arrangement in a plurality of iterations during an ongoing simulation.

Optionally, the method, the repeating is performed in a rate of at least 25 Hz.

Optionally, the measuring is performed in six degrees of freedom.

Optionally, the physical property comprising an external pressure applied on the respective segment.

Optionally, the physical property comprising an internal pressure applied on the respective segment from at least one another segment of the physical object.

Optionally, each the prismatic element having a top face facing the outside of the volumetric arrangement.

Optionally, the physical object having a dermal surface; the adjusting comprising adjusting the volumetric arrangement to simulate spatially an incision substantially horizontally undermining at least a part of the dermal surface.

Optionally, the incision having a length of at least one centimeter.

Optionally, the physical object having an eyeball surface; the adjusting comprising adjusting the volumetric arrangement to simulate spatially an incision substantially horizontally undermining at least a part of the eyeball surface.

Optionally, the method further comprises generating the volumetric arrangement according to an imaging at least a portion of an organ, the simulating being performed as a preoperative simulation.

Optionally, the method further comprises selecting the volumetric arrangement according to at least of medical an imaging at least a portion of an organ, the simulating being performed as a preoperative simulation.

Optionally, the physical object is an organ; further comprising selecting the volumetric arrangement according to at least of medical data pertaining to the organ.

Optionally, the physical object is an organ; wherein the spatially simulating comprising visualizing the organ using volumetric arrangement in a remote training system.

Optionally, the physical object is an organ; further comprising recording the adjusting to allow an evaluation of the performances of the user.

Optionally, the movement is at least one of substantially horizontal and substantially vertical to a plane defined by the outside surface of the volumetric arrangement, the adjusting comprising splitting the at least one prismatic element to form at least one additional prismatic element.

Optionally, the volumetric arrangement models a physical object having a non planner continuous surface.

Optionally, the measuring comprises detecting a grabbing movement, the spatially simulating comprising spatially simulating a tweezing of a portion of the physical object in response to the movement using the adjusted volumetric arrangement.

Optionally, the measuring comprises detecting a pushing movement, the spatially simulating comprising spatially simulating a pressure applied on a portion of the physical object in response to the movement using the adjusted volumetric arrangement.

Optionally, a first group of the plurality of prismatic elements having at least one adjustable parameter simulating a physical property of a first biological tissue and a second group of the plurality of prismatic elements having at least one adjustable parameter simulating a physical property of a second biological tissue.

Optionally, the spatially simulating comprising spatially simulating at least one rigid object in proximity to the physical object.

According to some embodiments of the present invention there is provided a device of simulating an incision or a deformation formed in a physical object. The device comprises a database of storing a volumetric arrangement of a plurality of prismatic elements, each the prismatic element having at least one adjustable parameter simulating a physical property of a respective segment of the physical object, a display means which displays a simulation of the physical object in a simulation space according to the volumetric arrangement, a movement measuring unit which measures a movement of at least one simulation tool in the simulation space, and a computing unit which selects at least one of the plurality of prismatic elements according to the measurement, adjusts the at least one adjustable parameter of the at least one selected prismatic element according to the measurement, and simulates spatially at least one of an incision and a deformation formed in the physical object in response to the movement using the adjusted volumetric arrangement.

Optionally, the volumetric arrangement is a multilayer arrangement wherein each layer having a group of the plurality of prismatic elements arranged as a continuous surface.

Optionally, the movement measuring unit is a haptic device.

Optionally, the simulation tool is selected from a group consisting of a scalpel, a marker, and tweezers.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of a method of simulating a formation of an incision and/or a deformation in a physical object by a tool, according to some embodiments of the present invention;

FIG. 2 is a schematic illustration of a simulation system of spatially simulating the effect of a tool, such as a cutting tool, on at least a portion of a physical object, such as a human organ, according to some embodiments of the present invention;

FIG. 3 is a schematic illustration of an exemplary simulation system of spatially simulating the effect of a tool on a physical object using haptic devices and a head mounted display, according to some embodiments of the present invention;

FIGS. 4A and 4B are schematic illustrations of an exemplary triangular prismatic element of a volumetric arrangement, according to some embodiments of the present invention;

FIG. 5 is schematic illustration of an exemplary portion of a volumetric prismatic arrangement simulating a continuous surface, according to some embodiments of the present invention;

FIG. 6 is schematic illustration of an exemplary volumetric prismatic arrangement shaped to have a topology of a face, according to some embodiments of the present invention;

FIG. 7 depicts an extended barycentric coordinate system for a prismatic element which is used for defining the location of a point in the prismatic element, according to some embodiments of the present invention;

FIG. 8A is an exemplary schematic illustration of a scalpel forming an incision in a top base of a prism in proximity to the center of a certain spring, according to some embodiments of the present invention;

FIG. 8B is an exemplary schematic illustration of a vertical incision simulated in a visual representation based on a volumetric arrangement, according to some embodiments of the present invention;

FIG. 9, which depicts an undermining incision made by a simulated scalpel in some prisms' arrangement, according to some embodiments of the present invention; and

FIG. 10 is an exemplary image of a visual representation based on a volumetric arrangement which is shaped to simulate a face under deformation, in a semi-transparent mode, allowing the user to view the internal anatomy through the simulated skin, according to some embodiments of the present invention.

### DESCRIPTION OF EMBODIMENTS OF THE INVENTION

The present invention, in some embodiments thereof, relates to method and system of simulation and, more particularly, but not exclusively, to method and system of simulating surface incisions, deformations and interactions therewith.

According to some embodiments of the present invention there is provided a method and system of simulating an incision and/or a deformation of a physical object such as a near surface body part in response to a real time movement of a simulation tool, such as a cutting tool. Such system or method allows simulating the forming of a substantially vertical incision, an undermining incision, and/or a deformation, such as pulling and/or pushing effect. These effects simulated may be simulated in a physical object such as an organ, for example a face, a limb, an abdomen portion and the like. The simulation may include a feedback effect and/or the simulation of neighboring tissues. The simulation optionally takes into account external forces, such as gravity and/or air pressure and/or internal effects, such as pressure applied by neighboring tissues and/or organs.

The simulation is based on a volumetric arrangement of prismatic elements, optionally, triangular, which share common faces. The elements are optionally arranged to form a prismatic element based mass-spring model. Optionally, the prismatic elements are defined according to one or more physical limitations, such as spring length limitations, which are used to simulate the reaction of the simulated physical, optionally non linear, object, to the formed incisions and/or deformations. For example, the physical limitations are set to simulate the effect of a living skin tissue, such as a facial skin tissue, to an incision formed therein and/or to external pressure applied thereon.

By using prismatic elements, as outlined above and described below, a volumetric arrangement that may react in real time to a number of consecutive operations, such as deformations and/or incisions, in light of physical properties of a simulated physical object, for example organ, is formed. The simulation may be of a surgery. As used herein, real time data means calculating or measuring without introducing a delay of more than several milliseconds to the computational process. In use, the volumetric arrangement's topology is adjusted according to the movement of one or more tools which are set to simulate surgical tools, such as a scalpel, a marker, and tweezers and/or manual work tools.

According to some embodiments of the present invention, there is provided a method of simulating a formation of incisions and/or deformations in a physical object, such as a body organ. The method is based on spatially simulating the physical object in a simulation space using a volumetric arrangement of a plurality of prismatic elements. Each prismatic element has adjustable parameter(s) which simulate a physical property of a respective segment of the physical object. For example, the adjustable parameters may include masses and adjustable springs which define the prismatic element where each pair of masses is connected by one of the adjustable springs and the length of the adjustable spring, which is effected by the masses, simulate a tension applied on a respective segment of the simulated object by internal and/or external forces. Now, a movement of one or more simulation tools, such as a scalpel, is measured in the simulation space, for example using a haptic device. Prismatic elements that simulate segments of the physical object which should have been affected by the movement of the simulation tool are selected and their adjustable parameters are adjusted to spatially simulate an incision and/or a deformation formed in the physical object in response to the movement.

According to some embodiments of the present invention, there is provided a method of simulating a formation of an incision in a physical object. The method is based on spatially simulating the physical object in a simulation space using a volumetric arrangement of a plurality of prismatic elements each having a set of masses and springs. During the simulation, external and/or internal forces are computed for some or all the springs. The forces which are applied on each spring are accumulated in respective masses which are connected thereto do that a movement of each mass is computed from forces. Adjustments made to the volumetric arrangement, for example as a result of measuring the movement of simulation too, are applied while ensuring that springs do not pass physical limitations which may be simulated by defining maximal elongations for them.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

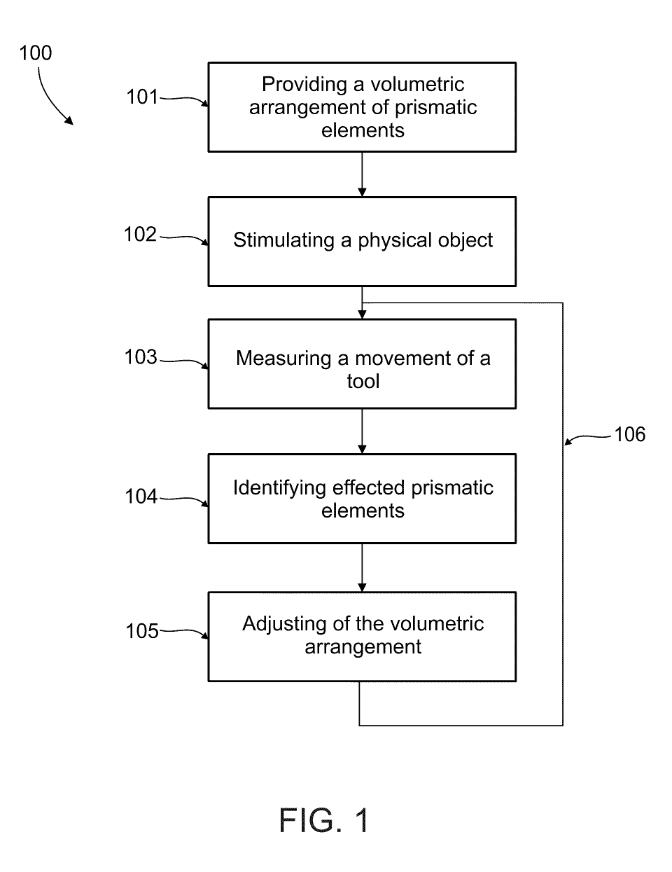

Reference is now made to FIG. 1, which is a flowchart 100 of a method of simulating a formation of an incision and/or a deformation in a physical object by a tool, such as a surgical tool, according to some embodiments of the present invention. For example, the physical object may be a body organ any portion thereof and the simulated incision is an incision formed by a surgical tool, such as a simulated scalpel. As used herein, a simulation space means a physical space in which manipulation and/or movement of simulation tools, such as real and/or dummy tools, is measured.

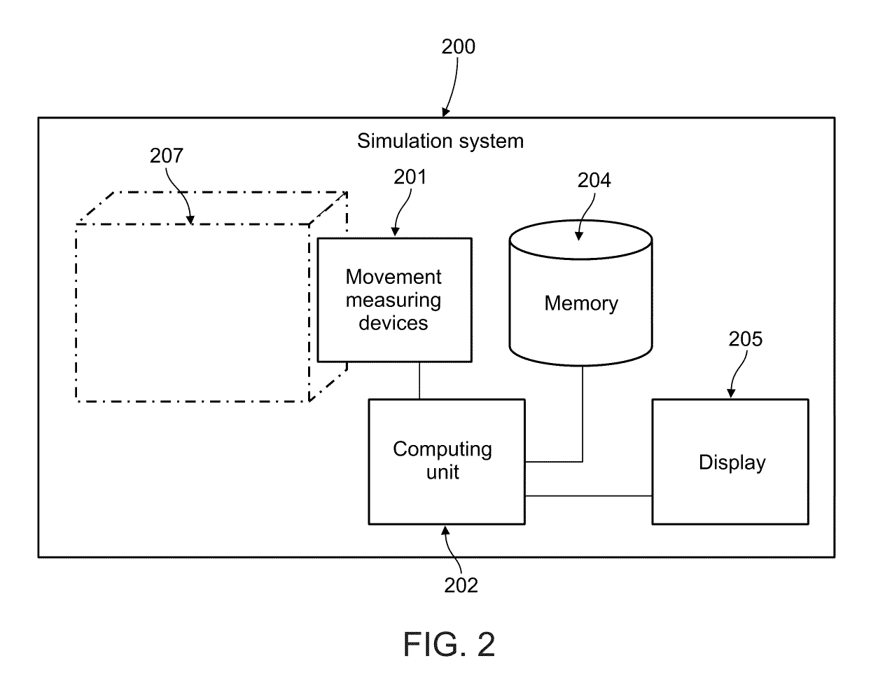

Reference is also made to FIG. 2, which is a schematic illustration of a simulation system 200, such as surgical or manual work simulation system of spatially simulating the effect of a tool, such as a cutting tool, on at least a portion of a physical object, according to some embodiments of the present invention. The simulation system 200 optionally uses a prismatic element based model for simulating the cutting a human organ, for example a face, a limb, an abdomen and/or any other object with continuous, optionally non linear surface. The system 200 includes one or more movement measuring units 201, optionally with force feedback capabilities. These movement measuring units 201 allow measuring the movement of one or more simulation tools, optionally surgical, such as a scalpel, a hook, tweezers, in a simulation space 207 and optionally provide force feedback according to a model of the simulated objects. During simulation, a user, such as a practicing surgeon may manipulate and/or move the movement measuring units 201 in a simulation space 207 as he would use surgical tools during a surgery. As used herein, measuring the movement includes measuring the motion vector, the applied force, the velocity, the displacement, the acceleration, the torque, and/or the momentum of each tool in the simulation space 207.

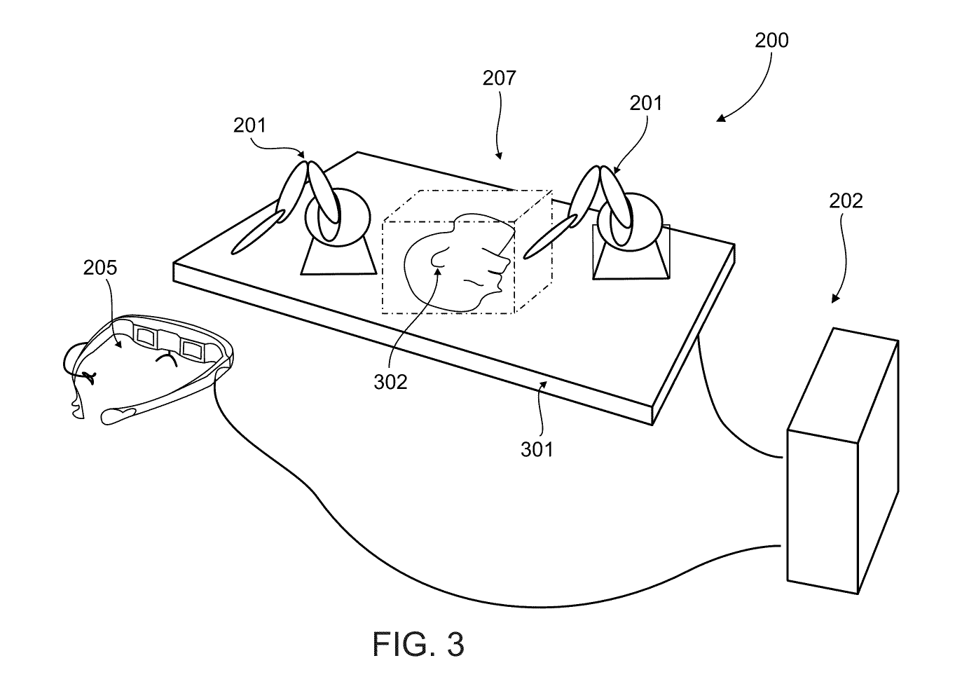

Optionally, the simulation tools are held similarly to a pen. Several off-the-shelf movement measuring units 201 may be suitable for the measuring the movement of such tools, for example the PHANTOM Omni™ movement measuring unit of SensAble Technologies™, which the specification thereof is incorporated herein by reference. FIG. 3 depicts an exemplary system 200 in which the movement measuring units 201 are such haptic devices 201, placed on a surface 301, such as a table.

Each movement measuring unit 201 is set to measure the movement of a simulation tool when it is manipulated or moved by a user. The manipulation is performed in the three-dimensional space, namely the movement in forward/backward, up/down, and left/right axes (translation in three perpendicular axes) combined with rotation about three perpendicular axes (pitch, yaw, roll). Optionally, the movement measuring units 201 are set to measure movement, optionally in an update rate of more than 1 KHz, along each of the three axes, which is independent of movement in other axes and independent of the rotation about any axis, namely each movement measuring unit 201 is set to measure a motion having six degrees of freedom.

The movement measuring units 201 are connected to a computing unit 202 that receives movement measured by the movement measuring unit 201. The movement measuring units 201 is connected to a memory 204 storing a model that allows generating a visual representation of a physical object and a display 205 for displaying the physical object in a space, optionally in the simulation space. The display 205 is optionally a spatial display device, a two dimensional (2D) display emulating a three dimensional (3D) object, such as a liquid crystal display (LCD), a three dimensional (3D) display, a head mounted display (HMD), as shown at FIG. 3 and cave automatic virtual environment (CAVE).

The computing unit 202 is set to compute a simulation of the effect of the movement measured by the movement measuring units 201, for example as described below. The computing unit 202 adjusts the topology of the simulated physical object to simulate the effect of the movement of the simulation tool. Additionally or alternatively, the computing unit 202 operates a feedback mechanism according to the simulation, for example using a feedback mechanism which is integrated into the movement measuring units 201.

Optionally, the computing unit 202 operates the display 205, and optionally other presentation units, to simulate a space surrounding the simulation space 207, for example the look and feel of a surgery room. Optionally, a voice command module is used to receive voice instructions, for example starting a simulation, replacing a simulated tool and the like,

Optionally, a partial physical environment is provided to allow the user to feel parts of the environment which do not interact with the virtual tools, for example the operation table 301 and the head 302 depicted in FIG. 3. For example, when a facial plastic surgery is simulated, the top half of the operation table is constructed, including a model of the head where the simulated physical object is removed, for example a Styrofoam based model.

Reference is now made, once again, to FIG. 1. First, as shown at 101, a volumetric arrangement of a plurality of prismatic elements, optionally triangular, is provided. The volumetric arrangement, which may be stored in the memory 204, is optionally set to simulate an organ selected for a simulation. The volumetric arrangement size and shape are set to allow visualizing the organ and operations which are performed thereon, for example as described below.

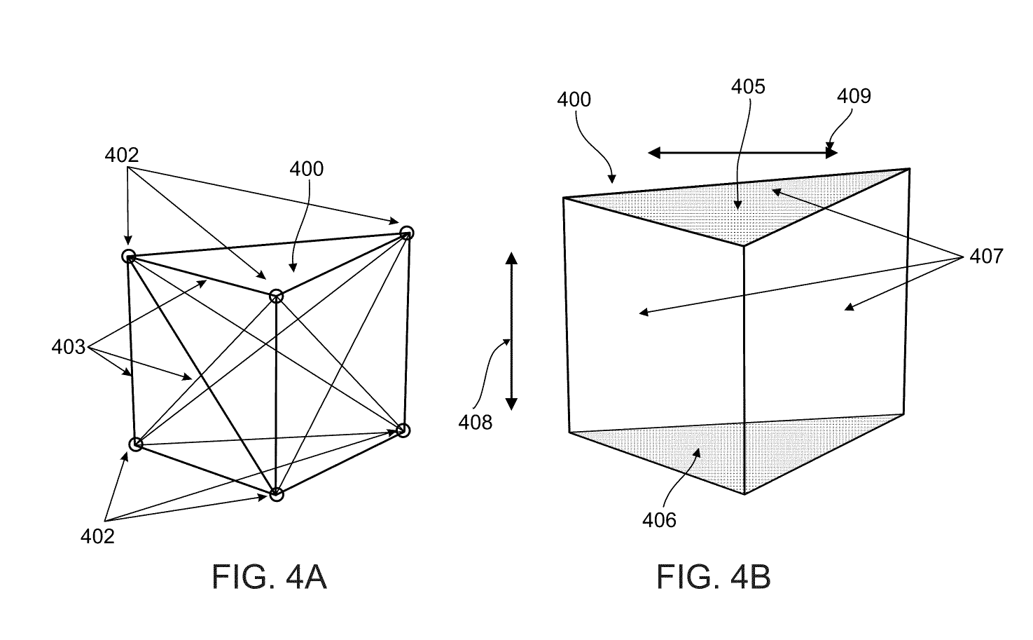

As described above, the volumetric arrangement includes prismatic element, optionally triangular. Each prismatic element has one or more adjustable parameter(s) which simulate one or more physical properties of a respective segment of the simulated physical object. For example, the adjustable parameters may simulate internal and/or external forces which are applied on respective segments of the simulated physical object. In the embodiments described below, the adjustable parameters are set according to a spring-mass model. FIG. 4A depicts an exemplary triangular prismatic element 400 which may be referred to herein as a triangular prismatic element or a prismatic element. Even though a triangular prismatic element is depicted in FIG. 4A, the prismatic element maybe shaped as any polyhedron made of an n-sided polygonal bottom base, a transformed copy as top base, and n faces joining corresponding sides. Note cross-sections parallel to the base faces are not necessarily the same. Optionally, the prismatic elements are used with a mass spring model modified to approximate non-linear properties of the physical object having a dermal surface, such as a skin, a cardiac surface, and/or an eyeball surface for simulating the making of a vertical incision, undermining incision, and/or deformations. In such embodiments, each prismatic element 401 includes a plurality of masses 402, such as the vertexes of a prismatic element. Each mass 402 is connected to any other mass 402 using an adjustable spring, such as shown at 403. FIG. 4B depicts the faces of the prismatic elements. Numerals 405 and 406 show the top and bottom faces, which may be referred to herein as bases. Numeral 407 shows the side faces, which may be referred to herein as sides.

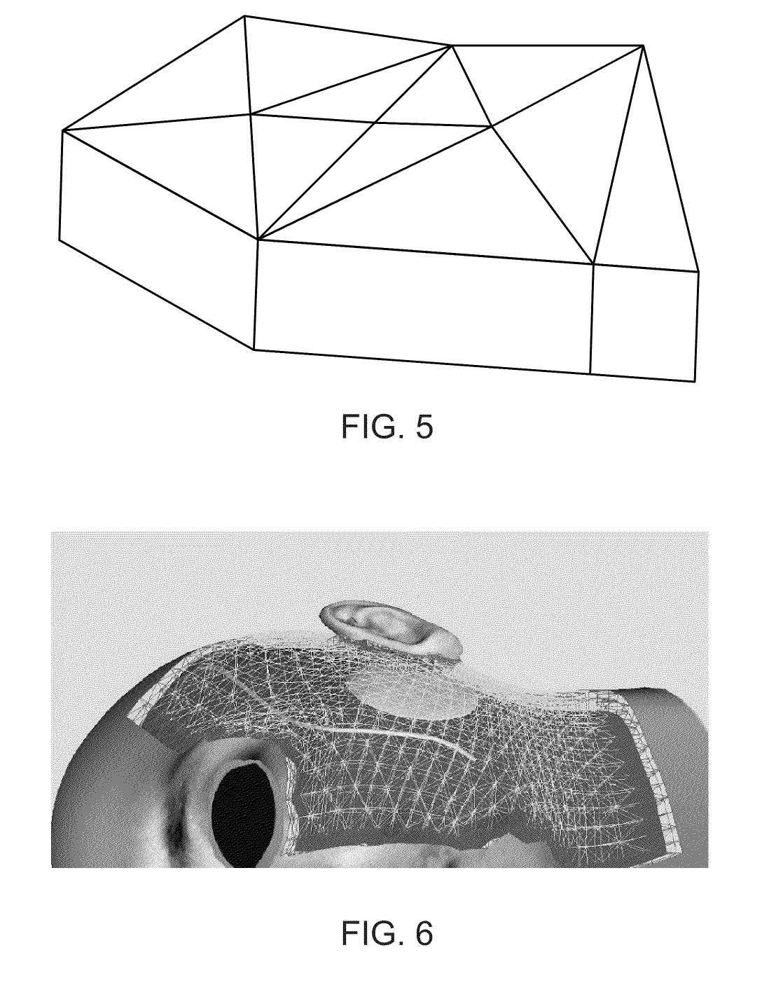

In order to simulate internal and/or external physical forces, which are applied on a respective subspace of the simulated physical object, each adjustable spring is set with one or more adjustable values. For brevity, an axis parallel to a side face of a prismatic element may be referred to as vertical, as shown at 408, and an axis contained in a base of a prismatic element may be referred to as horizontal, as shown at 409. When simulating a continuous non linear surface, such as a skin tissue, the top base may be an external side and the horizontal axis may be tangent on a simulated surface of a skin, for example as shown in FIG. 5.

Optionally, the mass spring model allows simulating, in real time, the (time) response of the physical object to a simulation tool that applies external forces thereon. The simulation is optionally performed in an iterative process so that each iteration takes into account the effect of previous iterations. In use, in each iteration, a simulation of external forces, such as user applied stress, air pressure, gravity, and the like, is combined with internal forces coming from values representing contractions and/or elongations of the springs are accumulated at the masses. This allows relocating the masses according to accumulated forces for following iterations.

It should be noted that gravity has an important noticeable effect on loose skin when the arrangement is used for simulating a surgery, such as a facial plastic surgery, for example as shown in FIG. 6. Optionally, the external force is implemented by adding a force vector pointing downwards to each one of the masses in a common world coordinates. Moreover, an air pressure has a noticeable effect when deforming a physical object in a manner, which extends its total volume. Air pressure avoids the creation of matter-less volumes (vacuum) by pushing the surface inwards to fill this vacuum. The effect of the air pressure is implemented by adding a force vector pointing in direction of a normal at each face of a prismatic element it is applied on. The magnitude of the force vector is proportional to the area of the polygons in a set of masses around the mass, which may be referred to as the mass's ring, to simulate the effect of external pressure.

According to some embodiments of the present invention, each spring has one or more physical limitation values which are set to simulate the response of a simulated continuous surface, such as a live skin tissue, to an incision and/or a deformation formed by a movement of a simulated tool. For example, the physical limitation is a surface stretchability coefficient, such as a living skin tissue stretchability coefficient. Optionally, the incision's length is unlimited and may be more than one or a few centimeter long. For example several centimeters long, as performed in facial surgeries and/or significantly more, for example in cardiac procedures. Optionally, the physical limitation values are set to define the reaction of the spring to external and/or internal forces applied thereon. In such a manner, the reaction of the physical object, which is represented by an arrangement of spring based prismatic elements, may be bound to physical limitations which imitate the physical limitations of a simulated object, such as a live skin tissue. Optionally, the physical limitation values set a two-phase stress response, which bound the reaction of a spring to non maximal and maximal lengths. In a first phase, simulating a low stress, a spring shows a standard linear behavior, meaning a force f applied on the two masses it connects is linearly proportional to f αΔx elongation and in the opposite direction: f=−kΔx. In a second phase, simulating a high stress, a spring is at his maximal length so that it does not increase in length. This behavior approximates the properties of a continuous surface, such as a skin, which stretches up to a certain elongation and then remains almost un-stretchable. Additionally or alternatively, the physical limitation values set a two-phase stress response, which bound the reaction of a spring to non minimal and minimal lengths. In a first phase, simulating a low reversed stress, a spring shows a standard linear behavior, meaning a force f applied on the two masses it connects is linearly proportional to f αΔx elongation and in the opposite direction: f=−kΔx. In another phase, simulating a particularly high but reverse stress, a spring is at his minimal length so that it does not decrease in length. This behavior approximates the properties of a continuous surface, such as a skin, which does not decrease in length to less than a certain elongation and even remains substantially undrinkable. For example, in the prismatic element depicted in FIG. 4A, the vertical surface of the prismatic element is defined by two matching pairs of masses from both prismatic element bases where each prismatic element has three sides and every two masses in each prismatic element are connected by an exemplary spring, creating a formation that resists stretching above a predefined force in every direction, as well as sheering and rotational forces. Optionally, as depicted in FIG. 3, a total of 15 springs are assigned to each prismatic element.

As described above, the prismatic elements are arranged in the volumetric arrangement. Optionally, the prismatic elements are arranged so that adjacent prismatic elements share masses and springs, for example as shown in FIG. 6. A prismatic element may be either connected to another prismatic element at its base, forming a multilayer arrangement or at its side, forming a continuous surface. Optionally, a physical object, such as a human organ, may be constructed using layers of connected prismatic elements. Different layers may have different spring values so as to simulate different tissues.

A prismatic element that has neighboring prismatic elements at all sides and bases may be referred to herein as an internal prismatic element while another may be referred to an external prismatic element. Though such internal prismatic elements may not be visible to the user, its effect on the simulation is noticeable, as it may apply internal force on neighboring prismatic element, for example as further described below. It should be noted that during the simulation of an incision in response to a movement of a tool, such as surgical tool, for example a scalpel, internal prismatic elements may become external prismatic elements as prismatic elements may be disconnected and new faces may be respectively created to divide shared masses and springs to separate sets of masses and springs in different side faces.

In order to simulate the effect of the simulation tool and external and/or internal forces over time on the physical object, the bases of the prismatic elements may be not placed on the same plane, on parallel planes, and/or coincide in area. As such, the masses defining the side faces of the prismatic elements may not be coplanar. When a side face of non internal prismatic element is visible, we approximate its visual representation using a number of triangular to bases, for example 2. However, the actual volume of a prismatic element is enclosed between the top and bottom, optionally triangle, bases, and (three) sides, each defined by four mass points defining bilinear surfaces. In such a manner, the volume defined by adjacent prisms does not include holes, and that the prismatic elements are mutually exclusive, a property which we will later use when considering internal geometry.

Optionally, the volumetric arrangement is selected from a set of various scenarios representing different physical objects, for example a plurality of organs, plurality of body parts, a plurality of different layers of material, a plurality of organs having different criteria, for example simulating an organ of a user having different medical information and/or condition, such as age, gender, medical history, weight, body mass index (BMI), race and/or any combination thereof.

Optionally, the volumetric arrangement may be adjusted according to various criteria, such as medical information and/or condition. Different volumetric arrangements may introduce different topologies so as to allow a user to practice the manipulation, for example the makings of incisions, such as undermining incisions, in different physical objects that require different surgical and/or manual work operations. Optionally, the shape and/or layout of additional physical objects which are simulated as being in proximity with the area near the simulated physical object are set in according to the selected volumetric arrangement. In planning the mass spring model system, by positioning the masses, assigning their sizes and setting spring properties correctly, allows achieving an approximation to a behavior of a continuous surface.

As described herein, the volumetric arrangement is set to simulate one or more soft tissues and one or more incisions formed therein by tools, such as a scalpel or a razor, for example, during a surgery, such as a plastic surgery. The simulated soft tissues may include skin, cartilage, ligaments, tendons, adipose pads, and even collagen and large blood vessels. The simulation of different tissues may be done by changing the values of the springs of respective prismatic elements to correspond with respective physical properties and limitations. Optionally, one or more rigid objects, such as bones are simulated in proximity to the volumetric arrangement and/or as part of the volumetric arrangement. In such a manner, possible interactions of a surgical tool with bones in proximity to the soft tissues are simulated. A volumetric arrangement that simulates various tissues allows simulating various interactions, such as vertical and horizontal incisions, deformation, and/or tweezing which are held during various surgeries. For example, a skull may be simulated as a union of ellipsoids for a simplified approximation. In use, during iteration of an iterative simulation, the location of masses of internal prismatic elements are matched against the ellipsoids and mass found inside one of the ellipsoids are repositioned, for example pushed to nearest points outside the ellipsoids.

According to some embodiments of the present invention, the volumetric arrangement is set to simulate an organ of a patient that is about to be operated. In such a manner, the visual representation of the volumetric arrangement can be used for performing a preoperative simulation. In such an embodiment, an imaging, such as a 3D imaging, of the organ which is about to be operated on may be taken. For example a computerized tomography (CT) and/or a magnetic resonance imaging (MRI) image is received to allow the extraction of the topology of internal and/or external tissues of the organ. This allows generating a volumetric arrangement that simulates a specific patient's topology of internal and/or external tissues of the organ. A transparent display could also serve on accessibility planning aid for a specific patient and/or planning new surgical procedures. Optionally, the volumetric arrangement is set to simulate a surgical situation for tutorial reasons. Such a volumetric arrangement may be used for examination of surgeon performances, possibly recorded over time, teaching and/or training where an instructor guides others to perform a procedure in a training session, possibly even in a remote training session.

As shown at 102, a physical object is spatially simulated in the simulation space 207 by using the volumetric arrangement. Optionally, the provided volumetric arrangement is used for simulating a physical organ to one or more users, for example by generating a visual representation and presenting it on a display, optionally a spatial display device. The visual representation may be generated by converting the volumetric arrangement to a physical model, and registering its virtual coordinates to match coordinates of the haptic devices 201, the display, external instruments, such as an operation table and a Styrofoam model. The registration is done, manually or automatically, per volumetric arrangement. For example, the following process describes the generation of a registered volumetric arrangement used to simulate a physical object as follows:

1. A 3D geometric mesh model is selected to match the used display, for example an HMD. For best results and stability, the physical model requires this to be a rather uniform mesh. The model is opened using any CAD program and several ellipsoids are added so that together they approximate the position and shape of the skull this model should have had.

2. The simulation space is marked on the 3D model. For example, in a certain facial surgery simulation, the area around the left cheek of the model was selected, from the top of the neck up to slightly above the temporal bone, excluding the ear. For each point of the physically active region a depth can be entered to represent the thickness of the deformable region at that location. For our purposes a constant depth was selected.

3. Volumetric arrangement layout construction. The normals of each vertex of the active region are calculated. Each vertex in the active zone turns into a mass in the physical model. A second layer of masses is created at the location defined by extending a line from each original vertex in the direction of its normal to a given distance.

Similarly, additional layers of masses may be created according to the required number of prismatic element layers, with the total depth described above. A prismatic element is then created from each face by using its base masses as the top base, and the three matching masses from the next mass layer. Next layers of prisms are created similarly by using three masses originating from a face, and three matching masses from the next layer. This process defines the whole volumetric arrangement.

4. The faces of the original model are assigned to the top layer of prismatic elements defined in the previous step, completing the generation of the physical model.

5. For registration, three external points (V₁, V₂, V₃) are selected on the virtual model, in a way that defines a triangle with a large area.

6. Each point Vᵢ is presented on the display in turn, and the user uses the haptic device to select a matching point Pᵢ on the Styrofoam model.

7. The affine transformation, A, that matches all three virtual points vᵢ, iε1, 2, 3 to the three physical points Pᵢ, iε1, 2, 3 is found.

8. A is applied to transform the position of the simulation tool to the virtual coordinates.

9. A transformation for the 3D display is found similarly, for example matching the physical location of an HMD to the virtual simulation coordinates.

Optionally, all the prismatic elements of the volumetric arrangement are registered in a coordinate system. Optionally, the volumetric arrangement is registered in a barycentric coordinate system so that a modulation of the base and the inner height of each prismatic element, such as a triangular prismatic element, are set as prismatic element coordinates. As described above, the bases may not be identical or placed on parallel planes. Thus, to emulate curved surfaces, and allow deformations, a prismatic element coordinate system that does not make these assumptions, is used. The coordinates of a prismatic element of a point inside it, are given as the triplet (u, w, h), where u, w, hεE [0, 1], u+w≦1. The h parameter is a generalized height. Using the location of the three masses from the top triangular base

$$( v \frac{1}{1} , v \frac{1}{2} , v \frac{1}{3} )$$

and the location of the matching masses from the bottom base

$$( v \frac{2}{1} , v \frac{2}{2} , v \frac{2}{3} )$$

where parameter h prescribes a triangle, who's vertices are located at

$$[ hv \frac{1}{1} + ( 1 - h ) v \frac{2}{1} , hv \frac{1}{2} + ( 1 - h ) v \frac{2}{2} , hv \frac{1}{3} + ( 1 - h ) v \frac{2}{3} ] .$$

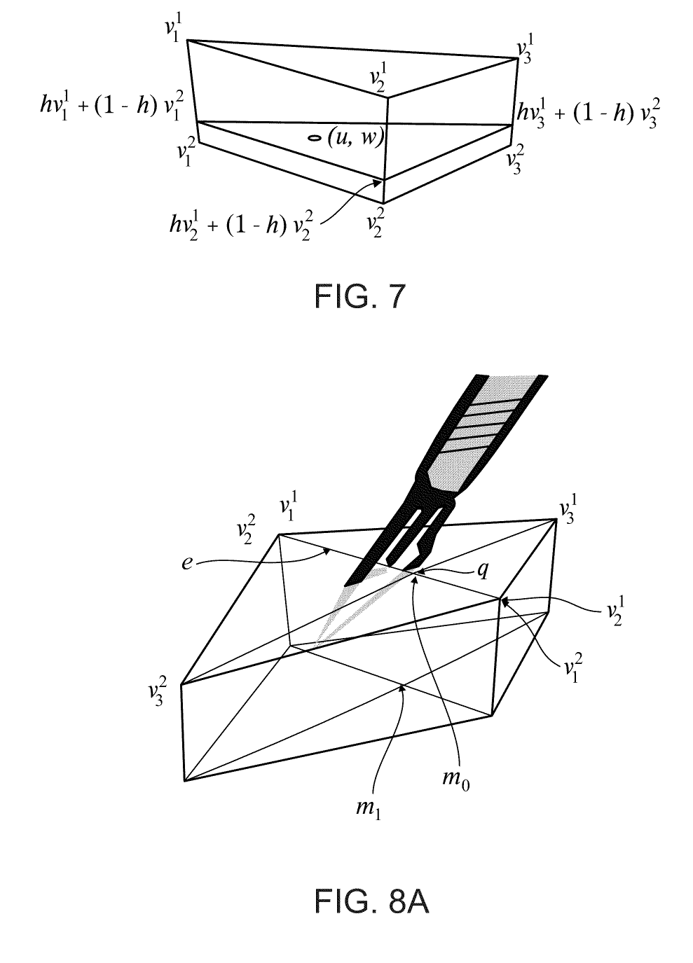

For (h=0, 1) this defines the two bases and every value therebetween defines a unique triangle inside the prismatic element. Next, (u, w) values are used to represent a point inside this triangle, using a standard barycentric coordinate system, for example as shown at FIG. 7. This representation of prismatic element coordinates maps the whole volume of a triangular prismatic element, as depicted in FIG. 3 and ensures C⁰ continuity between adjacent prisms.

In order to simulate an interaction and/or a deformation of internal anatomy located inside a layer of prismatic elements, a coordinate system for each prismatic element must be generated. Optionally, the deforming or adjusting of a prismatic element is done by calculating the effect of a pressure and/or incision point thereinside, for brevity denoted herein as q. The point q is defined by the triplet (u, w, h). The prismatic element coordinates of each vertex of the internal geometry are calculated to add a near surface anatomy to the simulation. This is done as follows, for each vertex q=(qx, qy, qz) of the internal anatomy:

1. Potential prisms that may contain q are found by searching over all prisms. For each prismatic element P, if the q is not inside the bounding box of P, the prismatic element is purged. Otherwise go to step 2.

2. P's vertices

$$( v \frac{1}{1} , v \frac{1}{2} , v \frac{1}{3} ) and ( v \frac{2}{1} , v \frac{2}{2} , v \frac{2}{3} )$$

and the unknown height to parameter h, are used to define the family of triangles: T(h)=(hv₁²+(1−h)v₁²,hv₂²+(1−h)v₂²,hv₃²+(1−h)v₂³)
This parameterizes the volume between the two bases of the prismatic element.

3. The h value of the plane defined by the triangle T(h), that contains the vertex in question, q, is found the constraint of T(h) contain q. Denote by (Tₓⁱ(h),T_{y}ⁱ(h),T_{z}ⁱ(h)), iε1, 2, 3 the (x, y, z) coordinates of the vertices of the triangle T(h). Finding h is done by solving the following determinant:

$$\vert \begin{matrix}{T}_{x}^{1} - {q}_{x} & {T}_{y}^{1} - {q}_{y} & {T}_{z}^{1} - {q}_{z} \\ {T}_{x}^{2} - {q}_{x} & {T}_{y}^{2} - {q}_{y} & {T}_{z}^{2} - {q}_{z} \\ {T}_{x}^{3} - {q}_{x} & {T}_{y}^{3} - {q}_{y} & {T}_{z}^{3} - {q}_{z}\end{matrix} \vert = 0.$$

This determinant defines a cubic equation in h for which all solutions hε[0, 1] are examined.

4. For each value of hε[0, 1], the triangle it defines, T, is extracted, and the barycentric coordinates (u, w) of q in it, are found. This can always be done since q is on T's plane, by construction.

5. If exist such (u, w) so that q is inside T (i.e. u, w≧0, v+w≦1), then q is assigned the containing prismatic element P and the prismatic element coordinates (u, w, h). Assuming the internal anatomy input is contained in the prismatic element structure, and recalling that all prismatic elements are mutually exclusive, a prismatic element P that contains q exists and is unique. If no two triangles in T(h) intersect for hε[0, 1], (h, u, w) are unique.

Now, as shown at 103, a movement of one or more simulation tools, for example of the simulation tools of the movement measuring units 201, in the simulation space 207 is measured. The movement is optionally measured by the movement measuring units 201 while the user participates in a manual work simulation, such as a surgical simulation. As depicted in FIG. 1 and described above one or more haptic devices 201 may be used to allow simulating interactions between tools, such as surgical tools, and a physical object simulated using volumetric arrangement having a plurality of prismatic elements. The movement coordinates of the one or more haptic devices 201 are coordinated or registered with coordinate system of the volumetric arrangement.

During a surgical simulation, each haptic device simulates a marker, a tweezer, a scalpel and/or any other medical tool. Optionally, the haptic devices 201 measure changes of the location of the tools in an update rate of 1 KHz or more, for example as described in Hong Tan, J. Radcliffe, Book No. Ga, Hong Z. Tan, Brian Eberrnan, Mandayarn A. Srinivasan, and Belinda Cheng, Human factors for the design of force-reflecting haptic interfaces, 1994, which is incorporated herein by reference. During a simulation, movement may be measured in about 1 KHz by the haptic inputs.

As shown at 104, the measurements are forward to a computing unit, such as shown at 202 of FIG. 2 that identifies a group of prismatic elements which simulate a portion of the simulated object that should be affected by the measured movement. The group may be selected by registering the movement coordinates to the coordinate system of the volumetric arrangement.

This allows, as shown at 105, adjusting the volumetric arrangement so as to simulate spatially an incision and/or a deformation formed in the physical object in response to the measured movement, for example by changing its topology. The simulation is performed by adjusting the values of the springs of the prismatic elements which are selected in 104, optionally in light of the physical limitations which are defined thereto. For example, the physical limitations include a surface stretchability coefficient, such as a living skin tissue stretchability coefficient, which define maximum and minimum spring lengths.

As shown at 106, blocks 103-105 may be iteratively repeated to allow the simulation of one or more incisions in the simulated physical object during a period of several seconds, minutes, and/or hours.

Optionally, a simulation executed as depicted in FIG. 1 may be recorded to allow evaluating the performances of the practicing user, for example a student, and/or its improvement over time. Such data may be used for producing a report, manually and/or automatically. The recording may include timing of each action and the like.

Continuous 3D recordings of such simulation sessions may also serve as Continuous 3D training movies which can be distribute with ease.

Optionally, for improving the visual result of the simulation, the movements are measured in an update rate of about 1 Khz or more. In order to allow simulating physical changes which are induced by the simulated movement, for example an incision, deformation and/or tweezing of the simulated physical organ, a calculation that updates the volumetric arrangement in a similar update rate is provided herein.

The simulation runs at approximately 40 Hz, resulting in a force output every, approximately, 25 msec. Let vector F(x(tᵢ),y(tᵢ),Z(tᵢ)) denote a force vector to be applied on top of the haptic device 201, as calculated at time t, which denotes a current time step of the simulation. The curve F(t)=(x(t),y(t),z(t)) is calculated separately for each axis. Consider, as an example, x(t)=C₂t²+C₁t+C₀, a parabola interpolating the x component of the Force vector. Given three samples (tⱼ, x(tⱼ)), jε{i, i−1, i−2}, finding the coefficients C₂, C₁, C₀ is a matter of solving a 3×3 linear system Ax=b:

$$( \begin{matrix}{t}_{i}^{2} & {t}_{i} & 1 \\ {t}_{i - 1}^{2} & {t}_{i - 1} & 1 \\ {t}_{i - 2}^{2} & {t}_{i - 2} & 1\end{matrix} ) ( \begin{matrix}{c}_{2} \\ {c}_{1} \\ {c}_{0}\end{matrix} ) = ( \begin{matrix}x ( {t}_{i} ) \\ x ( {t}_{i - 1} ) \\ x ( {t}_{i - 2} )\end{matrix} )$$

where y(t), z(t) are calculated in a similar manner, resulting in a quadratic curve F(t) mentioned above, which interpolates the last three force calculations.

The haptic device(s) constantly measure the movement of the tool, which may be referred to as a haptic input, during the simulation, optionally at about 1 KHz. At any given moment tᵢ<t<tᵢ₊₁, there is no exact force information the haptic device should apply. In order to provide the haptic device with forces updated in haptic rates, F(t) is used as an approximation. To avoid the jumps that may occur when a new force sample is added (changing the quadratic curve coefficients instantaneously), smoothing is used.

Reference is now made to a description of forces calculation, using the described volumetric arrangement at the iterations. Forces from the haptic device 201 are not directly added to the masses of the prismatic elements as they are dependent input parameters which are directly related to the resistance that the haptic device applies, for example as a force feedback and as the haptic device interact with visible points on a visual representation of the volumetric arrangement, and not limited to applying force at mass points. As a result, an approximation of the affect of any interaction by applying forces on masses only is used. The approximation for a volumetric arrangement of, optionally triangular, prismatic elements is optionally set as follows:

1. Determining a constrained point defined by a triangular face T and barycentric coordinates (u, w) on the volumetric arrangement. This point may either be a current intersection point between the tool and the volumetric arrangement or a point a user has previously grabbed during the simulation.

2. Calculating the current location of the constrained point, denoted herein as q, from T using (u, w).

3. Translating the triangular face T done by translating the three masses that defines it so that a new location of the constrained point falls at the tip of the simulation tool. Optionally, the translation is performed by the equation: s−q where s denotes the current location of the tool's tip.

4. Calculating internal forces, which are spring based, and external forces, such as gravity, according to the new position of T. f₁, f₂, f₃ denote force vectors which are respectively calculated for Ts masses where f denotes a force vector which is defined as follows: f=a(u f₁+wf₂+(1−u−w) f₃). Such a force vector approximates the force direction at q from the force at the masses of T.

5. Applying forces on the masses and relocating them to their new position.

6. Repeating step 2 to force the constrained point back to its location.

7. Checking the physical limitation of the springs and correcting if needed.

8. Setting the new location of the constrained point as q_{new} and calculating a force vector f_{q}=β(s−q_{new}).

9. Generating a force feedback as a function of f and/or f_{q}, for example the combined force vector f+fq and sending it to the haptic device 201, using predefined force coefficients (α,β).

The force vector f approximates the force applied on the face T in order to hold it in place with the tool. The force vector f_{q} is proportional to the distance from the closest position for which the springs are in their allowed length range. This force resists user applied forces that constrain the springs to a not allowed length.

According to some embodiments of the present invention, simulation of the effect of different tools may use the force aforementioned force calculation differently. Reference is now made to a simulation of the effect of exemplary tools on the physical object. Optionally, the exemplary tools are tools used for simulating a surgery.

According to some embodiments of the present invention, the simulated tool is an incision tool, such as a scalpel, that is capable of cutting a physical object. The simulation of cutting the physical object involves simulating real-time changes in the structure of the visual representation of the volumetric arrangement as the geometry and topology changes around the cut during the formation thereof. In the suggested simulation, the prismatic elements, which are optionally triangular, are continuously rearranged and changed around an opening area formed in response to a simulated incision. Similarly to a simulation which is based on a geometric model limitation nor on prisms, for example as described in Guy Sela, Jacob Subag, Alex Lindblad, Dan Albocher, Sagi Schein, and Gershon Elber. Real-time haptic incision, simulation using fern-based discontinuous free-form deformation. Cornput. Aided Des., 39(8):685-693, 2007, which is incorporated herein by reference, the physically base simulation of the embodiments described herein includes the prismatic elements which are arranged in a manner that constantly puts pairs of prisms along the incision, one at each side of the incision curve, and their mutual side along the incision curve. This allows to disconnect the two prismatic elements sharing one side, and thus creating a smooth gradually opening incision. Since the volumetric arrangement is set according to physical limitations and properties of the simulated physical organ, rearranging the prismatic elements is done with a corresponding adaptation of the actual physical properties of the simulated physical organ. This is different from a simulation that is based on straight geometric models that cannot simulate an accumulated response of the physical organ to an incision operation.

For a surface incision, the following operations may be performed to simulate the effect of the movement of tool on a physical object by adjusting a volumetric arrangement having a plurality of prismatic elements, for example as described above:

1. The location of the simulation tool in a certain point on the surface of the visual representation of the physical object, for example on the skin of a virtual face in the simulation space, is identified and set as the initial incision location. When the force applied on the surface using the simulation tool passes a certain threshold, the surface is penetrated.

2. As the penetrated simulation tool moves along the top faces of the prismatic elements at the surface, it reaches a spring of one of the prismatic elements, which may be referred to herein as an edge, denoted herein as e.
(a) If the simulation tool is near one of the masses that e connects, the location of this mass point, denoted herein as m₀, and is applied with a force that triggers snapping thereof to the simulation tool's position. However, as m₀ is connected to a number of springs which resist this relocation, it may not simply move to the simulation tool's position. Optionally, the forces of the springs at the local neighborhood of m₀ are set to approximate a minimum energy state for m₀ at its new location. Note that correcting the rest length of these springs to their length after the mass relocation would yield a wrong arrangement, as this would affect the forces applied on the masses at other ends. Given the simulation tool's location at a triangular top face T, using barycentric coordinates, denoted b, allows relocating m₀ as follows:
   i. Denote by P₁, the prismatic element associated with T so that T is the top face of P₁. Denote by Pj the neighboring prismatic element from the j^{th} layer, such that Pj's bottom base, is the top base of Pⱼ₊₁. Similarly, mⱼ denotes the mass from the j^{th} layer, where there is a vertical spring between mⱼ and mⱼ₊₁. The following horizontal mass moving method is presented for mass m₀ of layer 0. The same method is applied for all masses mⱼ from all layers. Since moving the masses in all layers using this method leaves them at approximately the same vertical distance, the vertical springs are unchanged.
   ii. Denote by Sᵢ the horizontal springs connected to m₀, where e is one of them. Denote the rest length of Sᵢ by Lᵢ. Every S_{b} is signed with a length different from Lᵢ denoted herein as Δxᵢ.
   iii. Moving m₀ to its new location by using T and b for calculation (at other layers, the new location of mⱼ is found using the bottom base of Pⱼ or top base of Pⱼ₊₁, and b). The new signed length difference of Sᵢ is denoted Δxᵢ*.
   iv. The horizontal springs Sᵢ are corrected so that they apply the same magnitude of force as before the relocation of m₀. This is done by correcting the rest length Lᵢ of each spring as follows:

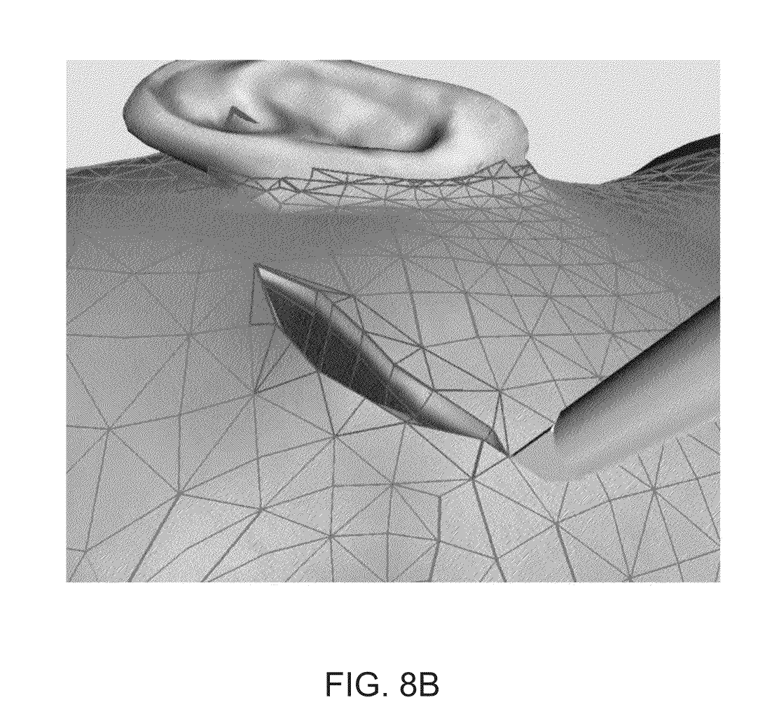

Lᵢ=Lᵢ−(Δxᵢ*−Δxᵢ).
The rest length of the diagonal springs connected to m₀ is updated using the updated horizontal springs and unchanged vertical springs from the same side. Assuming the mass makes only a small movement; the directions of the applied forces do not change much. The mentioned correction fixes the force magnitude and as a result, the new location has the same force balance as it previously had. In such a manner, the new spring parameters approximate the minimum energy state for the relocated mass.
(b) If the simulation tool is located at point q, which is relatively far from the end points of e, a mass is created at q, where the prismatic elements which share e are split as follows (for clarity, reference is made to FIG. 8A, which is an exemplary schematic illustration of a scalpel forming an incision in a top base in proximity to the center of a certain spring and FIG. 8B):
   i. e is set as the rest length L, and spring constant k. Let αε[0,1] be the relative position of the simulation tool on e, such that α=0 at one end of e, and α=1 at the other. Since e is a surface spring, the top bases of the prismatic elements which share e, set as P₁ and P₂, are set as

$${b}_{1} ( v \frac{1}{1} , v \frac{1}{2} , v \frac{1}{3} ) , {b}_{2} ( v \frac{2}{1} , v \frac{2}{2} , v \frac{2}{3} )$$

and the bases that contain e be e=v₁¹−v₂¹=v₂²−v₁² (v₁¹|=v₂², v₂¹=v₁²).
ii. e is split to form two springs with rest lengths L₁=αL and L₂=(1−α)L and spring constants k₁=k/α and k₂=k/(1−α). These springs are connected to a new mass m₀ at the split point.
iii. Two additional springs are created connecting m₀ to the masses opposite to the original edge e

$$( v \frac{1}{3} , v \frac{2}{3} )$$

at each of the two bases b₁, b₂ adjacent to e. Each of the two new springs is assigned a rest length as if it was at rest if it had connected m₀ to the opposite masses,

$$v \frac{1}{3} and v \frac{2}{3} ,$$

when all springs of this prismatic element were at rest. Assuming the rest lengths of the other edges of the current base are L₁=|v₁¹−v₃¹|, L|₂=|v₂¹−v₃¹|, the rest length of the new spring splitting it would be:

\sqrt{L₂²−α(L²+L₂²+L₃²)+α²L²}.
iv. i-iii are repeated, to split the matching spring from the bottom bases of P₁ and P₂, using the same α, adding the new mass m₁ at the split point. Then, the same method is used repeatedly to split the bases of the neighboring prismatic elements from the other layers, creating a new mass mⱼ at each layer j.
v. A new vertical spring is created at every prismatic element layer between mⱼ and mⱼ₊₁, with rest length equal to the average rest length of the vertical springs at this prismatic element side.
vi. Four new prismatic elements are created at each layer instead of the original two that were split at mⱼ. Diagonal springs are added where needed, with rest length calculated from the vertical and horizontal springs at the same prismatic element side.

3. The process described at step 2 puts a mass along the incision curve. As long as the incision is not aborted, the motion of the simulation tool which initiates this process is repeated and new masses continue forming along the incision path.

4. When there are three masses along the curve, denoted mₖ₋₂, mₖ₋₁, mₖ (last being mₖ), a prismatic element disconnection process is initiated. By definition of step 2, mₖ₋₂ and mₖ₋₁ are connected by a spring, and so are mₖ₋₁ and mₖ. Each of these springs are the top springs of a side of prismatic element, tracing the path of the simulation tool.

This side is shared by two prismatic elements, one at each side of the incision path. As the simulation tool moves, these prismatic element pairs are separated to form the opening incision, as described in below.

5. The simulation tool penetration depth is used to find the number of penetrated prismatic element layers d.

6. mₖ₋₁ and each of the d neighboring masses from the cut layers beneath are duplicated. Using mₖ₋₁ as a pivot, the prisms between mₖ₋₂ and mₖ in the clockwise direction are traversed, and set to use the new copy of mₖ₋₁ and the matching new masses from other layers. Since the prismatic elements from the other side of the cut (counter-clockwise) still use the original masses, this effectively separates the two sides of the incision.

7. A visible side face is added with a cut texture determined according to the cut depth, where prismatic element sides are exposed by the previous step.

8. An invisible spring is added between mₖ₋₁ and duplication thereof. It is added with a maximum length of zero, affectively holding them together, and then grows at a predefined rate up until it no longer limits the distance between the two masses. This process is planned to be quick, and could take less than a second. The purpose of this spring is to slow the opening of the incision, and make it a more continuous process over time. It is necessary in order to minimize jumping effects in the splitting of the discrete prisms.

9. mₖ is assigned with the next mass created along the cut path using step 2, and the process continues from step 4.

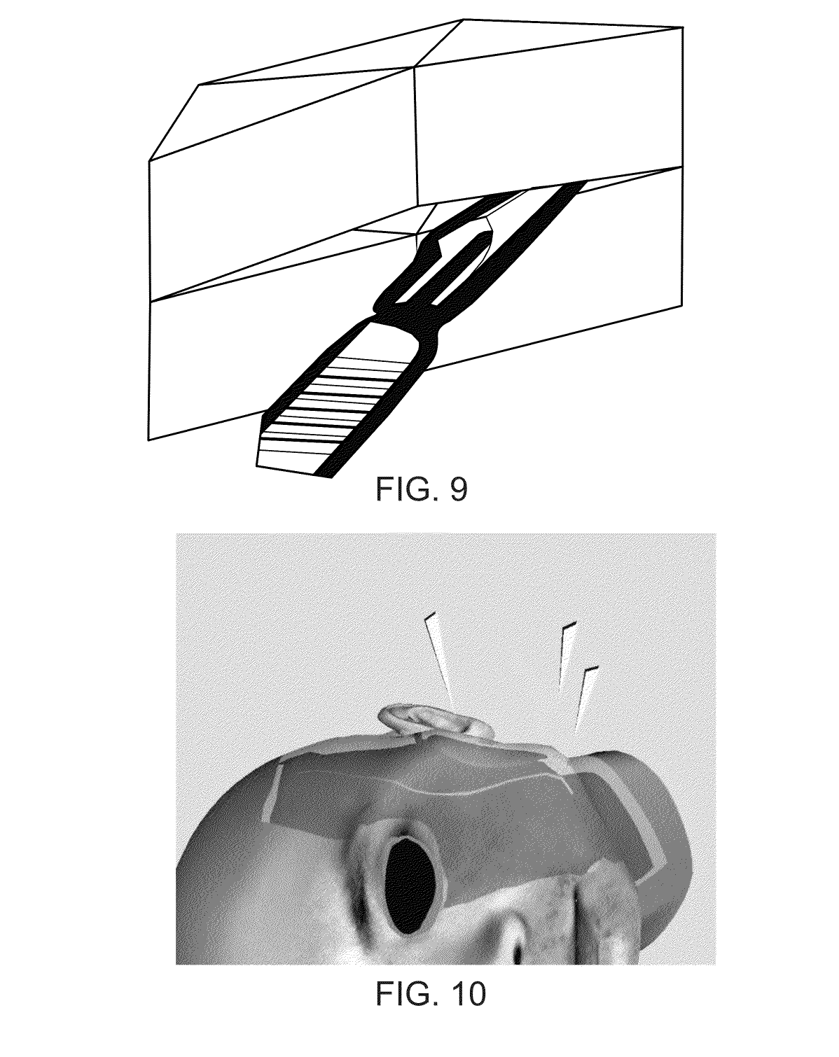

According to some embodiments of the present invention, the simulation may be set to simulate an undermining cut which is substantially parallel to the surface of the physical object, for example to the skin layer of a simulated organ, such as a face. The following operations may be performed to simulate the effect of a movement of tool performed to create an undermining incision in a physical object by adjusting a volumetric arrangement having a plurality of prismatic elements. The operations are described with reference to FIG. 9, which depicts an undermining incision made by a simulated scalpel. In this process, an array of prismatic elements the skin layer is disconnected from the underlying tissue using a simulation tool, such as a scalpel or scissors. For facial plastic surgery, this allows the surgeon to relocate the skin, as part of a face lift operation, for example. In our model the layered prismatic element layout allows achieving this rather easily. The undermining process starts from an existing incision. After an incision is performed by splitting the prismatic element layout that simulates the skin along the incision up to a certain depth, pulling one side of the incision reveals the near surface layers. Simulating the holding of the incision open with a hook or tweezers, for example as described below, in one hand, allows the simulating user, for example a surgeon, to use the simulation tool to separate the near surface layers with the other hand, for example by passing it between the skin surface and the fat tissue layer beneath it. The separation process is done as follows:

1. The process is initiated when the simulation tool penetrates an open incision from the side, between two prismatic elements from different layers, denoted P₁ for the top prismatic element and P₂ for the bottom prismatic element.

2. The mass m nearest to the penetrating simulation tool, such as a scalpel, at the prismatic element side, is found. By definition, m must belong to the bottom base, and visible side of P₁ and top base of P₂.

3. The top layer containing P₁ is separated from the bottom layer, connecting P₂ at m. Similar to the surface incision, m is duplicated and its duplications replace m at all the prismatic elements from the layer containing P₁. Since the prismatic elements from the layer below still use the original mass, this effectively separates the layers at this point.

4. New faces are created where prismatic element bases are exposed due to the separation, with the appropriate “internal” texture.

A slightly different process is used to continue the undermining procedure farther from the originally performed incision. While at the beginning of the undermining procedure, the simulation tool performed a cut at the side of a prismatic element, where the incision was made; to separate two from one another, farther from the incision the separation is done differently:

1. This process is initiated when the simulation tool penetrates a visible prismatic element P₁ separated earlier by an undermining procedure, and enters an internal unseparated pair of prisms behind it.

2. The simulation tool penetrates the prismatic element P₁ at a face T which is necessarily one of its bases (the case where the simulation tool penetrated the prismatic element from its side is already handled). Let the contact point of the simulation too with T be denoted q. The mass m, on face T, which is closest to q is found.

3. Using m as a pivot, the prismatic elements Pᵢ at the same layer of P₁, around m are examined, starting with P₁.

4. For each prismatic element Pᵢ from step 3, the base containing in is found. The first prismatic element Pᵢ that has a neighbor Pᵢ* sharing this base is found (when exists), and the separation is initiated. The mass m is duplicated to create m*.

5. If the separation has been initiated, all prismatic elements belonging to the layer of P; * having m at one of their bases, have m replaced by m*. This separates the two layers at mass m, creating two new visible bases instead of the single mutual (hidden) base they had before. Faces are inserted at these newly revealed bases.

When vertical and/or undermining incisions occur, the simulation tool moves inside the near surface material and the models of haptic forces which assume only external interaction with the prismatic elements cannot be used. During incisions, the force to be applied comes from the resistance of the tissue to cutting along the path of the simulation tool. The amount of resistance can be thought of as the number of tissue connections broken by the simulation tool, therefore, the incision force felt during time Δt is proportional to the amount of tissue connections broken during Δt. A number of factors are taken into account when estimating the number of broken connections at Δt:

1. The depth of the incision d. The deeper the scalpel penetrates, the more connections it breaks when moving.

2. Orientation of the simulation tool relative to the cut direction. The number of connections broken is proportional to the projection of the sharp edge of the simulation tool, on the direction perpendicular to the cut path. Denote the length of this projection (which depends on the shape of the scalpel) as l.

3. The speed of the simulation tool. The faster the simulation tool is moved, the more connections are broken at a given time step. Denote the speed of the scalpel by s.

Some of these factors depend on the simulation iterations, and some may be extracted from the haptic interaction alone. The depth of the incision depends on the simulation, as it requires the examination of the current relation between the simulation tool and the prismatic element it intersects. The angle of the simulation tool relative to the direction of the cut path, and the speed of the simulation tool, do not depend on the physical engine, only on the state of the simulation tool, which is sampled at haptic rates. At a haptic iteration, the three factors: d, l and s, are used to calculate the resisting force applied in the opposite direction of the performed incision as follows: f=λdls where λ denotes a coefficient tuned to best match the realistic feeling of performing a cut.

As described above, using a volumetric arrangement of prismatic elements allows simulating necessary operations for near surface surgery. The operations presented above allow maintaining the volumetric arrangement to simulate a physical object and the incisions which are performed thereon in every moment of a surgery simulation, with relatively simple adjustments.

It should be noted that when the vertical cut (incision) is described, a hidden assumption that the incision entering from the top base of the prismatic element, does not leave the prismatic element from one of its sides is made, In such a manner, only prismatic elements formed when splitting the prismatic element and other shapes such as tetrahedrons are avoided. To limit these occurrences to a minimum, the prismatic elements arc initially created at proportions that reduce the likeliness of this event, by setting the height of the prismatic elements as relatively smaller than the length of their base.

Having relatively flat prismatic elements make it difficult to enter the prismatic element with the simulation tool from the top base, and not exist from the bottom base. However, having the prismatic elements too flat would make them less resistant to sheer forces, which are simulated by the diagonal springs, thus reducing the realism of the model. In practice, an application specific compromise between the two considerations should be found.

An educational feature mentioned earlier with special relevance to the simulation tool is the deformable internal anatomy.

As mentioned earlier, the internal organs, blood vessels and nerves contained in the near surface area are deformed along with the near surface layers. This feature has two main uses in our simulation. First, the simulator allows drawing the skin in a semi-transparent mode, allowing the user to view the internal anatomy through the skin, for example as shown at FIG. 10. In such a manner, deforming and cutting the skin of the user can examine the affect of his actions on the near surface anatomy. While this does not simulate a true medical operation, it may be an extremely effective tool for learning. When performing incisions the internal anatomy plays an important role as well. After practicing in semi-transparent skin mode, the skin may be set to opaque mode, and the complete surgery can be performed without any hint regarding the location of the deformed internal anatomy. During this mode, the simulator continuously checks for collisions with the deformed internal organs, and if such collision occurs, points the user's attention to the hit organ. To be able to complete this task, the user must be perfectly familiar with the near surface anatomy and well practiced with handling a simulation tool such as a scalpel.

According to some embodiments of the present invention, the simulated tool is a pushing tool, such as a marker, that is not incapable of pulling or cutting a physical object and therefore only affects the model by pushing. When such a tool is simulated this case, the constraint point is always the location where the marker currently intersects with the surface. Optionally, if the simulated tool is a marker, ability to draw a wide line on the surface of the visual representation is simulated, just as a surgeon does when planning a surgical operation which involves incisions. Since a common usage of the marker is drawing curves where incisions are planned, it is most convenient to draw the line directly on the texture image of the visual representation, for example of a simulated face, thus avoiding a separate line drawing, deformation and cutting. However, since texture coordinates are not necessarily isometric to a 3D surface, drawing the line on the texture image needs to be done in a manner that corrects these distortions in order to receive a line of constant width on the resulting model.

The approximation of a deformation of a volumetric arrangement of triangular prismatic elements, defined as described above, by a pushing element and the drawing of a line on the surface of a visual representation of the volumetric arrangement so may be performed as follows:

1. Calculating l_{b} iε{1, 2, 3} the length of edges ∥v₁−v₂∥, ∥v₂−v₃∥, ∥v₃−v₁∥ of triangle where q denotes a center of a circle of radius T to be drawn on surface of the volumetric arrangement and T denotes a triangle on a surface containing q. (V₁, V₂, V₃) denotes the vertices of T where each vertex Vᵢ has 2D texture coordinates (uᵢ, wᵢ).

2. Translating (uᵢ, wᵢ) so that (u₀, w₀) is at the origin. Denote the translated coordinates by ( u̅ᵢ̅, w̅ᵢ̅).

3. Considering a trivariate linear transformation:

$$M = ( \begin{matrix}α & γ \\ 0 & β\end{matrix} )$$

which operates on the translated texture coordinates ( u̅ᵢ̅, w̅ᵢ̅). Where the transformed texture coordinates are:

$$( {u}_{i}^{*} , {w}_{i}^{*} ) = M ( \frac{{\overline{u}}_{i}}{{\overline{w}}_{i}} ) = ( a {\overline{u}}_{i} + γ {\overline{w}}_{i} , β {\overline{w}}_{i} ) .$$

4. Finding parameters α, β, γ of transformation M for which the triangle defined by (uᵢ*, wᵢ*) on the parametric domain is coincident with T. This is done by finding when the lengths of the edges on the texture domain are equal to lᵢ, by solving:

∥(u₂*,w₂*)∥=l₁,

∥(u₃*,w₃*)∥=l₃,

∥(u₃*−u₂*,w₃*−w₂*)∥=l₂,

This is solved analytically once using Maple, for example as described MapleSoft. Maple 11. http://www.maplesoft.com/. 2007, which is incorporated herein by reference, yielding:

$$α = \frac{\sqrt{- \overline{{u}_{3}} {l}_{2}^{2} \overline{{u}_{2}} - \overline{{u}_{2} {u}_{3}} {l}_{1}^{2} + {\overline{{u}_{3}}}^{2} {l}_{1}^{2} + {l}_{2}^{2} {\overline{{u}_{2}}}^{2} + {l}_{3}^{2} \overline{{u}_{2} {u}_{3}}}}{\overline{{w}_{2} {u}_{3}} - \overline{{u}_{2} {w}_{3}}} , \\ β = \sqrt{- \frac{{l}_{3}^{4} + {l}_{2}^{4} + {l}_{1}^{4} - 2 {l}_{3}^{2} {l}_{2}^{2} - 2 {l}_{3}^{2} {l}_{1}^{2} - 2 {l}_{1}^{2} {l}_{2}^{2}}{- 4 \overline{{u}_{3}} {l}_{2}^{2} \overline{{u}_{2}} - 4 \overline{{u}_{2} {u}_{3}} {l}_{1}^{2} + 4 {\overline{{u}_{3}}}^{2} {l}_{1}^{2} + 4 {l}_{2}^{2} {\overline{{u}_{2}}}^{2} + 4 {l}_{3}^{2} \overline{{u}_{2} {u}_{3}}}} , \\ γ = \frac{2 \overline{{w}_{3} {u}_{3}} {l}_{1}^{2} + 2 {l}_{2}^{2} \overline{{w}_{2} {u}_{2}} + ( \overline{{w}_{3} {u}_{2}} + \overline{{u}_{3} {w}_{2}} ) ( {l}_{3}^{2} - {l}_{1}^{2} - {l}_{2}^{2} )}{2 ( \overline{{w}_{2} {u}_{3}} - \overline{{u}_{2} {w}_{3}} ) \sqrt{- \overline{{u}_{3}} {l}_{2}^{2} \overline{{u}_{2}} - \overline{{u}_{2} {u}_{3}} {l}_{1}^{2} + {\overline{{u}_{3}}}^{2} {l}_{1}^{2} + {l}_{2}^{2} {\overline{{u}_{2}}}^{2} + {l}_{3}^{2} \overline{{u}_{2} {u}_{3}}}} .$$

where a resulting transformation M defines a local distortion between the texture coordinates and the geometric coordinates of T. The inverse transformation M⁻¹ defines inverse distortion, converting geometric coordinates on the triangle, to texture coordinates.

5. Computing (u, w) texture coordinates of q. Then, M⁻¹ is applied on a circle of radius r, located at the origin, resulting in an ellipse E. Finally, ellipse E is drawn on the visual representation at (u, w).

It should be noted that the generation of such ellipse be similarly used to prevent the simulation of an incision or a tweezing of a rigid surface, such as a bone.

According to some embodiments of the present invention, the simulated tool is a grabbing tool, such as tweezers. The tweezers use the force calculation method mentioned above for both pushing and pulling. At each calculation iteration, the constrained point is selected as the point on the surface of the volumetric arrangement that intersects the tweezers. When a constrained point is selected, the user may press a button on the haptic device to grab this point so that from now on, and until the user releases the button, this is the constrained point. When grabbing a point, the user may lock the virtual tweezers' location, and disconnect them from the haptic device. This is useful to simulate holding one pair of tweezers while manipulating a second pair in another hand, when only one haptic device is used for simulating the movement of the tool. When the previous set of tweezers is locked, a new free pair of tweezers appears, allowing the user to continue interacting with the simulation using other tools as well, and also lock additional tweezers.

It is expected that during the life of a patent maturing from this application many relevant systems and methods will be developed and the scope of the term simulation tools, haptic device, and motion sensor is intended to include all such new technologies a priori.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method of simulating a formation of an incision or a deformation in a physical object, comprising:
a) spatially simulating a physical object in a simulation space using a volumetric arrangement of a plurality of prismatic elements, each said prismatic element having at least one adjustable parameter simulating a physical property of a respective segment of said physical object;
b) measuring a movement of at least one simulation tool in said simulation space;
c) selecting at least one of said plurality of prismatic elements according to said measurement;
d) adjusting said at least one adjustable parameter of said at least one selected prismatic element according to said measurement; and
e) spatially simulating at least one of a deformation or an incision formed in said physical object in response to said movement using said adjusted volumetric arrangement.

2. The method of claim 1, wherein each said prismatic element has triangular bases.

3. The method of claim 1, wherein each said adjustable parameter includes a plurality of masses and a plurality of adjustable springs, each said mass being connected to another said mass by one of said plurality of adjustable springs; said adjusting comprises adjusting, each said at least one adjustable parameter at least one respective said adjustable spring.

4. The method of claim 3, wherein each said adjustable spring has a length limitation simulating a surface stretchability coefficient, said adjusting being performed under respective said length limitation.

5. The method of claim 4, wherein said surface stretchability coefficient is a living skin tissue stretchability coefficient.

6. The method of claim 3, wherein said adjusting comprises computing at least one of external and internal forces for each said adjustable spring of said at least one adjustable parameter, accumulating said external and internal forces in respective said masses, calculating a relocation of said respective masses according to said accumulated forces and performing said adjusting according to said relocation.

7. The method of claim 1, wherein each said at least one adjustable parameter has at least one physical limitation and said adjusting being performed under respective said at least one physical limitation.

8. The method of claim 1, further comprising repeating said b)-e) using said deformed volumetric arrangement instead of said volumetric arrangement in a plurality of iterations during an ongoing simulation.

9. The method of claim 8, wherein said repeating is performed in a rate of at least 25 Hz.

10. The method of claim 1, wherein said measuring is performed in six degrees of freedom.

11. The method of claim 1, wherein said physical property comprising an external pressure applied on said respective segment.

12. The method of claim 1, wherein said physical property comprising an internal pressure applied on said respective segment from at least one another segment of said physical object.

13. The method of claim 1, wherein each said prismatic element having a top face facing the outside of said volumetric arrangement.

14. The method of claim 1, wherein said physical object having a dermal surface; said adjusting comprising adjusting said volumetric arrangement to simulate spatially an incision substantially horizontally undermining at least a part of said dermal surface.

15. The method of claim 1, wherein said incision having a length of at least one centimeter.

16. The method of claim 1, wherein said physical object having an eyeball surface; said adjusting comprising adjusting said volumetric arrangement to simulate spatially an incision substantially horizontally undermining at least a part of said eyeball surface.

17. The method of claim 1, further comprising generating said volumetric arrangement according to an imaging at least a portion of an organ, said simulating being performed as a preoperative simulation.

18. The method of claim 1, further comprising selecting said volumetric arrangement according to at least of medical an imaging at least a portion of an organ, said simulating being performed as a preoperative simulation.

19. The method of claim 1, wherein said physical object is an organ; further comprising selecting said volumetric arrangement according to at least of medical data pertaining to said organ.

20. The method of claim 1, wherein said physical object is an organ; wherein said spatially simulating comprising visualizing said organ using volumetric arrangement in a remote training system.

21. The method of claim 1, wherein said physical object is an organ; further comprising recording said adjusting to allow an evaluation of the performances of said user.

22. The method of claim 1, wherein said movement is at least one of substantially horizontal and substantially vertical to a plane defined by the outside surface of said volumetric arrangement, said adjusting comprising splitting said at least one prismatic element to form at least one additional prismatic element.

23. The method of claim 1, wherein said volumetric arrangement models a physical object having a non planner continuous surface.

24. The method of claim 1, wherein said measuring comprises detecting a grabbing movement, said spatially simulating comprising spatially simulating a tweezing of a portion of said physical object in response to said movement using said adjusted volumetric arrangement.

25. The method of claim 1, wherein said measuring comprises detecting a pushing movement, said spatially simulating comprising spatially simulating a pressure applied on a portion of said physical object in response to said movement using said adjusted volumetric arrangement.

26. The method of claim 1, wherein a first group of said plurality of prismatic elements having at least one adjustable parameter simulating a physical property of a first biological tissue and a second group of said plurality of prismatic elements having at least one adjustable parameter simulating a physical property of a second biological tissue.

27. The method of claim 1, wherein said spatially simulating comprising spatially simulating at least one rigid object in proximity to said physical object.

28. A device of simulating an incision or a deformation formed in a physical object, comprising:
a database of storing a volumetric arrangement of a plurality of prismatic elements, each said prismatic element having at least one adjustable parameter simulating a physical property of a respective segment of said physical object;
a display means which displays a simulation of said physical object in a simulation space according to said volumetric arrangement;
a movement measuring unit which measures a movement of at least one simulation tool in said simulation space;
a computing unit which selects at least one of said plurality of prismatic elements according to said measurement, adjusts said at least one adjustable parameter of said at least one selected prismatic element according to said measurement, and simulates spatially at least one of an incision and a deformation formed in said physical object in response to said movement using said adjusted volumetric arrangement.

29. The device of claim 28, wherein volumetric arrangement is a multilayer arrangement wherein each layer having a group of said plurality of prismatic elements arranged as a continuous surface.

30. The device of claim 28, wherein said movement measuring unit is a haptic device.

31. The device of claim 28, wherein said simulation tool is selected from a group consisting of a scalpel, a marker, and tweezers.
